(19) United States
(12) Patent Application Publication
(10) Pub. No.: US 2007/0192401 A1
(43) Pub. Date: Aug. 16, 2007

(54) System and method for synchronizing syndicated content over multiple locations

(76) Inventors: Gordon Weakliem, Denver, CO (US); Greg Reinacker, Highlands Ranch, CO (US)

Correspondence Address: COOLEY GODWARD KRONISH LLP;ATTN: PATENT GROUP, Suite 500, 1200 - 19th Street, NW, WASHINGTON, DC, 20036-2402, US

(21) Appl. No.: 11/355,330

(22) Filed: Feb. 16, 2006

(51) Int. Cl. G06F 15/16

(52) U.S. Cl. 709/202

(57) ABSTRACT

A system and method for synchronizing content among a plurality of user agents is described. In one embodiment an aggregator receives, from a particular user agent, a request for a listing of content feeds, and the request includes information that identifies the particular user agent from among the plurality of user agents. In response, the aggregator generates, as a function of the particular user agent that sent the request, a status identifier for each of the content feeds, wherein each of the status identifiers indicates whether a corresponding one of the content feeds has content available that the particular user agent has not received. The aggregator then sends a listing of the plurality of content feeds and the status identifiers to the particular user agent.

### FIELD OF THE INVENTION

The present invention relates generally to software tools for accessing content, and more particularly to software tools for providing regular updates to web-based content.

### BACKGROUND OF THE INVENTION

Millions of web pages are available as a source of news content for users of the Internet. These web pages take many forms, including, for example, articles, blurbs, and web logs (“blogs”), among others. In one approach, news content is published by inserting it into a web page (e.g., coding it into a HyperText Markup Language (HTML) file), which can then be viewed using a web browser.

There are drawbacks, however, to this approach. Users who wish to see content from a variety of sources must typically visit many different web sites. In addition, if the user later wants to obtain the most current content from all the sources, they must visit all the different web sites again. This is very time consuming, especially if the user is interested in many different types of content and/or sources.

One possible solution is a software application that automatically visits a number of web sites, extracts and presents content directly to the user. In particular, “feeds” have been developed as a way to publish news content in a structured format that facilitates identification and analysis. A feed (also known as a “news feed” or “blog feed”) can contain items (e.g., news items), metadata about the articles (e.g., title, date, and author), and/or metadata about the feed itself (e.g., title, URL, and last-updated timestamp). Some feeds are described by Resource Description Framework (RDF) statements and/or encoded using eXtended Markup Language (XML) (such as, e.g., the XML syntax RDF/XML, RSS, Atom). These features of feeds make it easier for applications to automatically collect and evaluate news content for presentation to the user.

The term “syndication XML” refers to XML that has been developed for feeds, such as Atom and RSS (“Really Simple Syndication,” “Rich Site Summary,” or “RDF Site Summary”). Since the general structure of a feed is known, it is possible to identify the news content within it. Software applications have been developed that work with content published using syndication XML.

Applications and/or application handlers, commonly known as “feed viewers,” “feed readers,” or “feed aggregators,” are capable of reading the syndication XML and presenting it to the user. These applications, may be implemented as on-line services and many support “aggregation,” which enables a user to specify multiple feeds and integrate their content into a single feed.

Although feeds have made it easier to access content, when a user desires to access an on-line aggregation site via one a particular user agent (e.g., an office computer, a home computer, a PDA, and/or a cellular handsets), the user may have to parse through items the user has already seen and/or read. For example, when a user accesses an on-line aggregator from work and reads ten items (e.g., news stories), then access the aggregator again via a mobile cellular-handset to read another five items, when the user arrives at home and desires to find out if there are any new items available to read, the user must navigate through the items at the aggregator without knowing whether the available items are the same fifteen items the user already read, similar items or completely new items. In addition to taking the user's time to parse through already read and/or seen content, downloading duplicate (e.g., read and/or seen) unnecessarily utilizes a user agent's bandwidth.

Although present systems are functional, they are not sufficiently efficient or otherwise satisfactory. Accordingly, a system and method are needed to address the shortfalls of present technology and to provide other new and innovative features.

### SUMMARY OF THE INVENTION

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

In one embodiment, the present invention may be characterized as a method for synchronizing content among a plurality of user agents (e.g., Internet-enabled devices) that are utilized by a user. The method in this embodiment includes receiving, from a particular user agent, a request for a listing of content feeds that includes information that identifies the particular user agent from among the plurality of user agents, and providing, as a function of the particular user agent that sent the request, a status identifier for each of a plurality of content feeds that indicate whether each content feed includes content that has not been received by the particular user agent. The listing of the plurality of content feeds and the status identifiers is then sent to the particular user agent.

In another embodiment, the invention may be characterized as a system for aggregating content. The system in this embodiment includes a subscriber database, and a content services module coupled to the subscriber database. The content services module in this embodiment is configured to receive a plurality of content items from a plurality of content providers, determine whether each of the content items is a new content item relative to previously received content items and assign an indicator to each new content item that indicates whether each new content item is an unread content item. The system also includes a user interface portion coupled to the subscriber database that is configured to receive, from a particular user agent, a request for a listing of content feeds that also includes information that identifies the particular user agent from among a plurality of user agents. In addition, the user interface portion is configured to generate, as a function of the particular user agent that sent the request, a status identifier for each of the plurality of content feeds that indicates whether each content feed has content available that the particular user agent has not received.

As previously stated, the above-described embodiments and implementations are for illustration purposes only. Numerous other embodiments, implementations, and details of the invention are easily recognized by those of skill in the art from the following descriptions and claims.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1 is a block diagram depicting an environment in which embodiments of the present invention may be implemented;

FIG. 2 is a block diagram depicting an exemplary embodiment of the on-line aggregator depicted in FIG. 1; and

FIG. 3 is a flowchart depicting a method in accordance with exemplary embodiments of the present invention.

### DETAILED DESCRIPTION

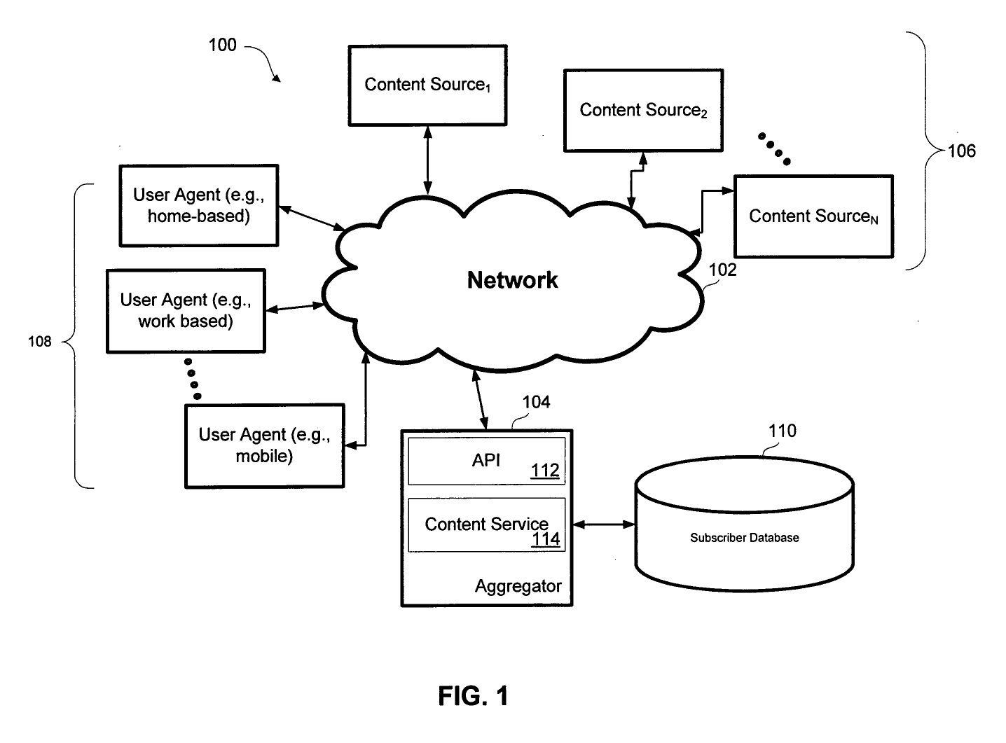

Referring now to the drawings, where like or similar elements are designated with identical reference numerals throughout the several views, and referring in particular to FIG. 1, shown is a block diagram depicting an environment 100 in which several embodiments of the present invention may be utilized to synchronize content among a plurality of user agents.

As shown, a network 102 couples a content aggregator 104 to both N content sources 106 and Nuser agents 108, and the content aggregator 104 is coupled to a subscriber data base 110. As depicted, the aggregator 104 in this embodiment includes an application programming interface (API) 112 and a content service portion 114. The aggregator 104 in several embodiments is realized by a combination of software and hardware. In many embodiments, for example, the aggregator 104 is implemented by software executed by a general purpose computer to effectuate functions described further herein.

The network 102 in several embodiments includes the Internet and may also include wide area networks and local area networks as well. The content sources 106 in this embodiment are web sites that make content (e.g., news content) available via feeds (e.g., RSS feeds) that are accessed by the aggregator 104. Each of the user agents 108 may be any one of a variety of Internet enabled devices including desktop and laptop computers, personal digital assistants (PDAs) and cellular handsets. In the exemplary embodiment, the user agents 108 are utilized to receive content items via selected feeds (e.g., as defined in a single user subscription) made available from corresponding content sources 106.

As described further herein, the aggregator 104 is configured to receive subscription information from a user via one or more of the user agents 108 to generate data defining a subscription to selected feeds made available by corresponding ones of the N content sources 106. In the exemplary embodiment, the subscription data is stored in the subscriber database 110 in connection with other information about the user (e.g., a username and password). In addition, the aggregator 104 periodically retrieves (e.g., every hour) and stores content items (e.g., news items) from each of the content feeds in the subscriber database 110 in order to gather content and make information available to the user about the content that is available from each of the content feeds.

In accordance with several embodiments of the present invention, the aggregator 104 advantageously synchronizes content items (also referred to herein as post items) among the user agents 108 to enable the user, while utilizing any one of the user agents, to readily identify, or avoid completely, content items the user has already viewed with another one of the user agents 108.

In many embodiments for example, a user is able to delete content items using one of the user agents (e.g., a mobile user agent) and have the deletion effectuated so that the user will not see the same item when later accessing the aggregator 104 with another user agent. In addition, when the user requests a subscription list with any one of the user agents, the aggregator 104 returns the subscription list that includes status identifiers, which indicate whether each corresponding content feed includes available content (e.g., one or more content items) that the particular user agent has not seen before.

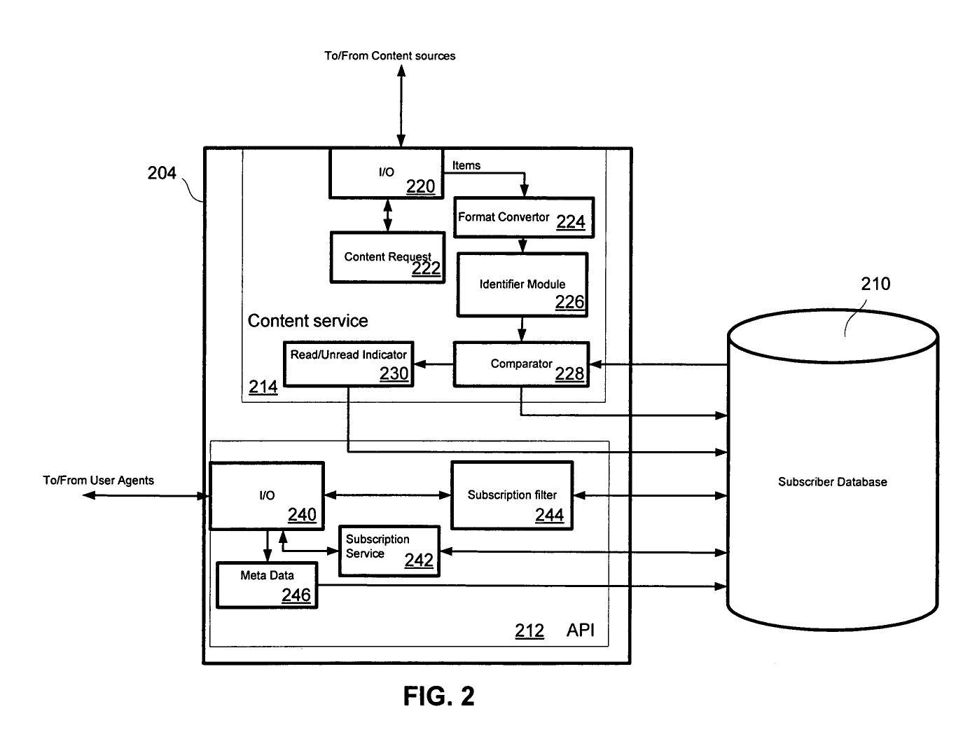

Referring next to FIG. 2, shown is an exemplary embodiment of the aggregator 104 depicted in FIG. 1. As shown, the aggregator 204 in this embodiment includes a content service portion 214, which includes an I/O portion 220 shown disposed to couple content sources (e.g., the content sources 106) with both a content request module 222 and a format converter 224. In addition, an identifier module 226 is shown coupling the format converter 224 and a comparator 228, which is also shown coupled to both a subscriber database 210 and a read/unread assignment module 230.

As depicted, an API 212 of the aggregator 204 in this embodiment includes a user I/O portion 240, which is shown coupled to a subscription service portion 242, subscription filter 244 and a metadata module 246. As depicted, the subscription service 242, subscription filter 244 and the metadata module 246 are also coupled to the subscriber database 210.

It should be recognized that the functional blocks depicted within the aggregator 204 are intended to represent functional aspects of the aggregator 204 and that some of the functions may be consolidated into one software or hardware module. In addition, the subscriber database 210 is depicted as a single component, but this is certainly not required and one of ordinary skill in the art will recognize that the subscriber database 210 may be realized by several distributed data storage devices.

In operation, a user initially establishes a subscription with the aggregator 204, which defines the content feeds that the user desires to receive content items from. In many embodiments for example, the subscription service 242 provides a web page with a graphical user interface that enables a user to select particular content feeds. Once the user has established a subscription, the subscription service stores the subscription information for the user in the subscriber database 210.

In some variations, the subscription service 242 is configured to enable the user to tailor the subscription on a user-agent by user-agent basis. In particular, the user in these variations is able to select, for each user agent, which content feeds to receive content items from. In this way, the user is able to receive content from particular content feeds only at particular user agents. In addition, in some embodiments the user is able to select, for each user agent, particular folders for each of the content feeds the user subscribes to. As a consequence, the subscriber database 210 in some variations includes, for each user, information about each of the user agents, subscription information and folder information.

The content service portion 214 in the exemplary embodiment generally functions to gather, identify and store content items in the subscriber database 210. In particular, the content request module 222 periodically (e.g., once an hour) initiates retrieval of content items from content feeds made available by the N content sources 106, and the content items are converted by the format converter 224 from a received format into a neutral format, and an identifier is either located or generated by the identifier module 226.

In many instances for example, content sources generate a global unique identifier (GUID) for each content item, which is parsed out from the content items by the identifier module 226. In other instances, content items arrive without a GUID, and the identifier module generates an identifier (e.g., by generating a hash of the content of each item). In one embodiment, the identifier module 226 identifies the content item using either the GUID or a hash and then generates another identifier, which identifies both the content item and the specific feed the content item originated from.

The comparator 228 then accesses the subscriber database 210 to compare identifiers of previously stored content items with the identifiers of the most recently received content items to determine the disposition of the most recently received content items relative to the previously received content items. In some embodiments, if a previously stored content item remains unread and is no longer being provided by a feed source it originated from, the item is archived in the subscriber database 210. In this way, content items (e.g., news stories), which are no longer current, are no longer automatically made available to a user, but are accessible to the user when the user specifically requests archived content from the aggregator 204.

If, however, one of the most recently received content items was previously deleted by a user, the most recently received content item is denoted by the read/unread assignment module 230 as a read content item. In contrast, if the recently received content item is a new content item, the item is denoted as unread by the read/unread assignment module 230, and a new record, including the content and an identifier for the content, is created and stored in the subscriber database 210.

If the recently received content item is identified by the comparator 228 as a modified content item (i.e., the most recently received content item includes new and or modified content relative to a stored content item), in some embodiments the user is given the option (e.g., via the subscription service 242) to have the content item denoted by the read/unread assignment module 230 as an unread item so that the user will receive the modified item.

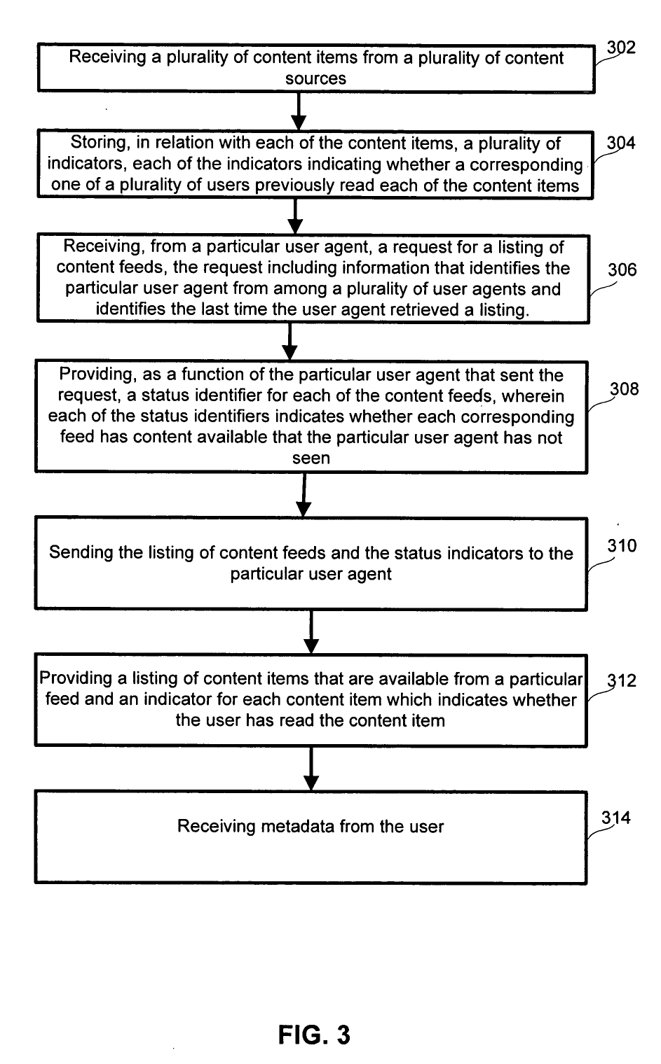

Referring next to FIG. 3, shown is a flowchart depicting steps that may be carried out by the aggregators of FIGS. 1 and 2. It should be recognized that the method depicted in FIG. 3 is described with reference to FIGS. 1 and 2 for example only and that the method is certainly not limited to the specific embodiment described with reference to FIGS. 1 and 2.

As shown, the aggregator 104, 204 initially receives content items from the content sources (Block 302), and stores, in relation to each of the content items, a read/unread indicator for each of the users that subscribes to the content items. In some embodiments for example, the indicator is a single bit that is stored in relation to both, an identifier for the content (e.g., a GUID or hash) and user information for a user subscribing to the content.

As depicted in FIG. 3, when a user requests a subscription list via a particular user agent (e.g., one of the user agents 108), the subscription filter 244 receives the request along with information, which identifies the particular user agent and the last time that the user agent retrieved a subscription listing from the aggregator 104, 204 (Block 306). In some embodiments for example, the user agent provides the subscription filter with a synchronization token (e.g., a time stamp), which informs the subscription filter 244 of the last time the user agent retrieved a subscription listing from the aggregator 204. In one embodiment, the synchronization token is a collection of data bits that are utilized by the subscription filter 244 to query the subscriber database.

In response to receiving the request for the subscription list, the subscription filter 244 retrieves, based upon the identity of the user agent, a listing of content feeds from the subscriber database 210 and provides a status identifier for each content feed, which indicates whether the content feed has content available that the user agent sending the request has not seen (Blocks 308, 310). In some embodiments, for example, the status identifier is either a “seen” or an “unseen” identifier, which indicates whether a particular content feed has content available that has not been received by the user agent.

In many embodiments, in addition to sending the status identifiers (indicating whether or not the content feed includes content the user agent has seen before), the aggregator 204 also sends an indicator for each content feed that indicates whether the feed includes a content item that has not been read by the user before. In this way, even if a particular content feed has content items available that a particular user agent has not seen before, the user can readily identify that they have already read (e.g., at another user agent) the available content items. As one of ordinary skill in the art will appreciate in view of this disclosure, the subscription listing, including status identifiers, read/unread indicators and any metadata, may be organized and sent to the user agent in accordance with online processor markup language (OPML).

In addition to status identifiers, in the embodiments where the aggregator 204 receives a synchronization token from the user agent, the aggregator 204 returns the token with an update indicating the time at which the aggregator generated the content feed listing. In this way, when the user agent again accesses the aggregator 204, the user agent will again pass the token back to the aggregator 204 to inform the aggregator 204 about the last time the user agent accessed the aggregator 204, and hence, inform the aggregator 204 about the content items the user agent has already seen.

As depicted in FIG. 3, when a user requests to view a listing of content items that are available from a particular content feed, the aggregator 204 provides the listing of content items and an indicator for each content item, which indicates whether the user has read each content item (Blocks 312, 314). In several embodiments, when the user requests the listing of content items, the subscription filter 244 queries the subscription database 210 utilizing filters to filter out those items that have either been read by the user and/or seen by the user agent before. Advantageously, in the exemplary embodiment depicted in FIG. 2, the user is able to establish, utilizing the subscription service 242, default filtering to be used by the subscription filter 244 when querying the subscriber database 210. As an example, the user may request that the subscription filter 244 only filter out items from the content item listing that have been seen by the user agent before, while allowing those items that have been read by the user (yet unseen by the user agent) to be returned to the user in the listing of content items.

Once the user has received the listing of content items, the user may then access the full content for a listed content item by following a link to the feed providing the content item. In several embodiments, the user may then return metadata to the aggregator 204, which indicates, for example, that the user has read the content item (Block 314).

In the embodiment depicted in FIG. 2, for example, the metadata module 246 receives metadata from a user that relates to one or more of a particular content feed, content item and/or user agent, and stores the metadata in the subscriber database 210 so as to be accessible at a later time.

The metadata may be an explicit indication that the user has read the content item, has not read the content item, has deleted the content item and/or an indication that the user has clipped content to a folder as well as other information. It is contemplated, for example, that the metadata may include tags, ratings and/or other annotations, which may then be associated, in the subscriber database 210, with a content feed, content item and/or user agent.

In conclusion, the present invention provides, among other things, a system and method for synchronizing content among a plurality user agents. In many embodiments, an aggregator provides, in connection with each feed in a listing of content feeds (e.g., news feeds), both an indicator (which informs a user whether each feed includes content that the user has not read) and a status identifier indicating whether each corresponding feed includes one or more content items that the particular user agent has not seen before. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A method for synchronizing content among a plurality of user agents that are utilized by a user, each user agent being capable of receiving content via network communications, the method comprising:
receiving via a network, from a particular user agent, a request for a listing of content feeds, the request including information that identifies the particular user agent from among the plurality of user agents and wherein each of the content feeds is associated with a corresponding one of a plurality of content sources; and
sending via the network, the listing of content feeds to the user agent, wherein the listing of content feeds includes a status identifier for each of the content feeds, and wherein each of the status identifiers indicates whether each of the content feeds has at least one content item available that has not been received by the particular user agent.

2. The method of claim 1 including:
receiving, from each of the content feeds, a plurality of content items;
determining whether each of the content items is a new content item relative to previously received content items; and
assigning an indicator to each new content item that indicates each new content item is an unread content item.

3. The method of claim 2, wherein the determining includes comparing a representation of each of the received content items with a representation of each of the previously received content items.

4. The method of claim 3, wherein the representation of each of the received content items is assigned by one of the plurality of content providers.

5. The method of claim 3, wherein the representation of each of the received content items is generated after receiving the content.

6. The method of claim 1 including:
selecting, as a function of the particular user agent that sent the request, particular content feeds to include in the listing of content feeds so as to provide a listing that is tailored to the user agent.

7. The method of claim 1 including receiving a token from the user, the token indicating the last time the particular user agent requested a listing of content feeds.

8. The method of claim 2 including:
receiving, from the user agent, an indication that one of the plurality of content items has been deleted.

9. The method of claim 2 including receiving, from the user agent, an indication that one of the plurality of content items has been read.

10. The method of claim 1 including:
receiving from the particular user agent, in connection with an identifier of one of a plurality of content items, user-defined metadata, wherein the metadata is selected from the group consisting of a flag, a tag, a rating and an annotation.

11. A system for aggregating content comprising:
a subscriber database;
a content services module coupled to the subscriber database, wherein the content services module is configured to:
receive a plurality of content items from each of a plurality of content feeds;
determine whether each of the content items is a new content item relative to previously received content items; and
assign an indicator to each new content item that indicates each new content item is an unread content item; and
a user interface portion coupled to the subscriber database, wherein the user interface portion is configured to:
receive, from a particular user agent, a request for a listing of content feeds, the request including information that identifies the particular user agent from among a plurality of user agents;
generate, as a function of the particular user agent that sent the request, a status identifier for each of a plurality of feeds, wherein each of the status identifiers indicates whether the particular user agent has received content items that are available at a corresponding one of the feeds; and
send the listing of content feeds and the status identifiers to the particular user agent.

12. The system of claim 11, wherein the content services module is configured to determine whether each of the content items is a new content item by comparing a representation of each of the plurality of received content items with a representation of each of the previously received content items.

13. The system of claim 12, wherein the representation of each of the plurality of received content items is assigned by one of the plurality of content providers.

14. The system of claim 12, wherein the representation of each of the plurality of received content items is generated after receiving the content.

15. The system of claim 11, wherein the a user interface portion is configured to query, in response to the request for the listing of content feeds, the subscriber database based upon the particular user agent so as to create a tailored listing of content feeds.

16. The system of claim 11, wherein the user interface portion is configured to receive, in connection with the request for the listing of content feeds, an indication of the last time the particular user agent requested a list of content feeds, and wherein the status identifier is generated by identifying content items made available subsequent to the last time the user agent requested the list of content items.

17. The system of claim 11, wherein the user interface portion is configured to receive, from the user agent, an indication selected from the group consisting of: an indication that one of the plurality of content items has been deleted, is unread and whether the item has been clipped.

18. The system of claim 11, wherein the user interface portion is configured to receive, from the user agent, in connection with an identifier of one of the plurality of content items, user-defined metadata, wherein the metadata is selected from the group consisting of a flag, a tag, a rating and an annotation.
